(19) United States
(12) Patent Application Publication
(10) Pub. No.: US 2014/0143093 A1
(43) Pub. Date: May 22, 2014

(54) KNOWLEDGE PRODUCT TRADING METHOD OF ONLINE STORE

(71) Applicant: ELECTRONICS AND TELECOMMUNICATIONS RESEARCH INSTITUTE, Daejeon (KR)

(72) Inventors: Rock Won KIM, Daejeon (KR); Seung Ik LEE, Chungcheongbuk-do (KR); In Hak JOO, Daejeon (KR); Yun Kyung PARK, Daejeon (KR); Chae Kyu KIM, Daejeon (KR)

(73) Assignee: ELECTRONICS AND TELECOMMUNICATIONS RESEARCH INSTITUTE, Daejeon (KR)

(21) Appl. No.: 14/056,789

(22) Filed: Oct. 17, 2013

(30) Foreign Application Priority Data
Nov. 19, 2012 (KR) 10-2012-0130627

(51) Int. Cl. G06Q 30/06

(52) U.S. Cl. CPC G06Q 30/0625
USPC 705/26.62; 705/27.1

(57) ABSTRACT

Disclosed is a knowledge product trading method of an online store. The knowledge product trading method as an operation method of an online knowledge trading system includes providing a knowledge authoring application (app), collecting knowledge from a knowledge provider through the knowledge authoring app, providing a knowledge service app, receiving a knowledge query request from a knowledge consumer through the knowledge service app, and selling the knowledge collected through the knowledge authoring app in response to the knowledge query request.

### CLAIM FOR PRIORITY

This application claims priority to Korean Patent Application No. 10-2012-0130627 filed on Nov. 19, 2012 in the Korean Intellectual Property Office (KIPO), the entire contents of which are hereby incorporated by reference.

### BACKGROUND

1. Technical Field

Example embodiments of the present invention relate in general to knowledge trade, and more specifically, to an online store for trading knowledge.

2. Related Art

User Created Contents (UCC) may signify moving pictures, text, audio, and images, which are created directly by users. A variety of contents which are provided by users through Internet portal sites, Social Networking Service (SNS), blogs, and the like, can also be seen as broadly UCC.

UCC can be seen as one type of user's personal experience information, and these personal experiences may be useful for reference when others wish to obtain their desired information. Here, these experiences are utilized either directly or indirectly as online search targets in the Internet portal sites, SNS, blogs, and the like.

However, such search-based information providing methods are used to find information knowledge created by a large number of individuals, and in most cases, individuals that create the information knowledge do not have ownership of the information knowledge. In addition, even when the individuals that create the information knowledge have ownership, the information knowledge is freely utilized by service providers without paying any compensation to the individuals.

In addition, a large number of pieces of information existing on the Internet have been searched in a method using text mining technology, and in order to overcome problems of the method such as inaccuracy, high cost, inefficiency, and the like, a variety of technologies such as semantic web, service-based web services, and the like, have been introduced. However, it is not easy to apply these technologies to UCC created by general users.

Accordingly, there are difficulties in paying compensation for knowledge and information which are created by users, and in providing the knowledge and information to others as knowledge products.

### SUMMARY

Accordingly, example embodiments of the present invention are provided to substantially obviate one or more problems due to limitations and disadvantages of the related art.

Example embodiments of the present invention provide an online store for trading knowledge products that may classify knowledge and information created by users through a network such as the Internet into meaningful knowledge products, and provide corresponding compensation.

In some example embodiments, a knowledge product trading method of an online store as an operation method of an online knowledge trading system includes: providing a knowledge authoring application (app); and collecting knowledge from a knowledge provider through the knowledge authoring app.

Here, the knowledge product trading method may further include providing a knowledge service app; receiving a knowledge query request from a knowledge consumer through the knowledge service app; and selling the knowledge collected through the knowledge authoring app in response to the knowledge query request.

In addition, the knowledge authoring app may be executed including or in conjunction with a knowledge authoring template having information and functions of a knowledge authoring interface, so that the knowledge provider easily authorizes knowledge of individuals as knowledge products including meta information.

In addition, the meta information may include at least one of knowledge type categories, properties of knowledge types, and relationships among knowledge types.

In addition, the knowledge authoring app may include at least one of a user situation perception function, a content generation function, a knowledge editing function, and a knowledge registration function.

In addition, the user situation perception function may infer a current behavior, a location, and a movement path of a user.

In addition, the knowledge product trading method may further include generating new knowledge by analyzing at least one item of the collected knowledge.

In addition, the knowledge service app may include at least one of a user situation perception function, a query generation function, a result viewer function, and a knowledge estimation function.

In addition, the knowledge service app may be executed including or in conjunction with a knowledge query template that provides a required function and operation sequence for providing a specific knowledge service, and information and a function about a query generation method for each function.

In addition, the knowledge service app may be executed including or in conjunction with a knowledge viewer template that provides information and a function about a method of showing, to a user, a query result for providing a specific knowledge service.

In addition, the user situation perception function may infer a current behavior, a location, and a movement path of a user.

In other example embodiments, a knowledge product trading method of an online store as an operation method of an online knowledge trading system includes: providing a knowledge service app; receiving a knowledge query request from a knowledge consumer through the knowledge service app; purchasing knowledge collected through a knowledge authoring app in response to the knowledge query request; and selling the purchased knowledge to the knowledge consumer.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing a knowledge product trading method of an online store according to an embodiment of the present invention;

FIG. 2 is a diagram showing an example of a function for each object in a knowledge product trading method of an online store according to an embodiment of the present invention;

FIG. 3 is a diagram showing an example of a knowledge-providing procedure of a knowledge product trading method of an online store according to an embodiment of the present invention; and

FIG. 4 is a diagram showing an example of a knowledge consumption procedure of a knowledge product trading method of an online store according to an embodiment of the present invention.

### DESCRIPTION OF EXAMPLE EMBODIMENTS

Example embodiments of the present invention are disclosed herein. However, specific structural and functional details disclosed herein are merely representative, for the purpose of describing example embodiments of the present invention. The present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

With reference to the appended drawings, exemplary embodiments of the present invention will be described in detail below. Elements that appear in more than one figure or are mentioned in more than one place in the detailed description are denoted by the same reference numerals throughout the application and are only described in detail once.

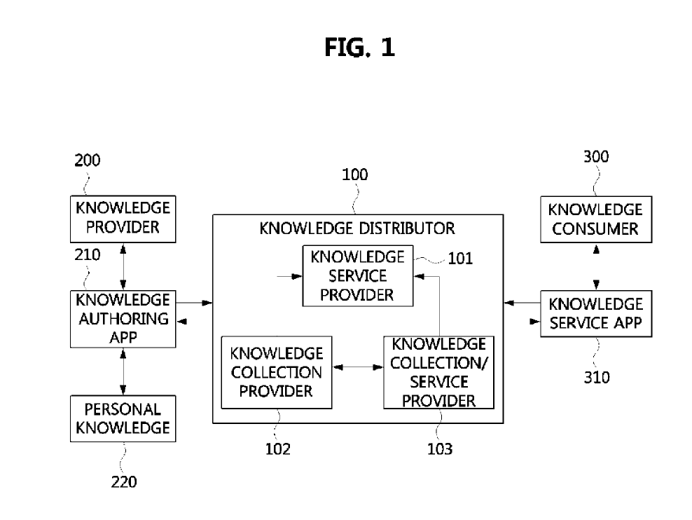

FIG. 1 is a conceptual diagram showing a knowledge product trading method of an online store according to an embodiment of the present invention.

FIG. 1 shows a knowledge distribution method and procedure, and a distribution flow in which experience-based knowledge of individuals is traded as products in a similar manner as in an online store that trades application programs or applications (apps) which operate in a wireless terminal

The knowledge product trade according to an embodiment of the present invention may include a knowledge distributor 100, a knowledge provider 200, and a knowledge consumer 300.

The knowledge distributor 100 is a distribution service provider that collects or sells knowledge products of individuals.

The knowledge service provider 101 is a knowledge distributor 100 that receives knowledge products required for knowledge services from a knowledge collection provider 102 and a knowledge collection/service provider 103, which are other knowledge distributors, without collecting knowledge directly from individuals who are the knowledge provider 200, and sells the knowledge products to the knowledge consumer 300, such as an individual or organizations.

The knowledge collection provider 102 is the knowledge distributor 100 that collects knowledge from individuals who are the knowledge provider 200 without selling knowledge products to the knowledge consumer 300 such as an individual or organization, processes the collected knowledge products as new high value-added knowledge products by analyzing the collected knowledge products, and provides the processed knowledge products to the knowledge service provider 101 and the knowledge collection/service provider 103 which are other knowledge distributors.

The knowledge collection/service provider 103 is the knowledge distributor 100 that collects knowledge from individuals who are the knowledge provider 200, processes the collected knowledge products as new high value-added knowledge products by analyzing the knowledge products, and provides the processed knowledge products to the knowledge service provider 101 and the knowledge collection provider 102, or sells the knowledge products to the knowledge consumer 300 which is an individual or organization.

The knowledge provider 200 signifies individuals that create knowledge products from their own experience and provide knowledge to the knowledge collection provider 102 and the knowledge collection/service provider 103 among the knowledge distributors 100, and creates the knowledge products using a knowledge authoring app 210 to provide the created knowledge products to the knowledge collection provider 102 and the knowledge collection/service provider 103.

Here, the knowledge products may be created in such a manner that the knowledge collection provider 102 and the knowledge collection/service provider 103 first request the knowledge products from the knowledge provider 200 which is an individual.

The knowledge consumer 300 may signify an individual or organization that purchases knowledge products provided by the knowledge service provider 101 and the knowledge collection/service provider 103, and purchases the knowledge products from the knowledge service provider 101 and the knowledge collection/service provider 103 using the knowledge service application (app) 310.

By a difference between trade of personal experience-based knowledge and trade of products using the existing Internet or app store, types or properties of knowledge products are not determined in a single form.

In addition, the knowledge collection provider 102 and the knowledge collection/service provider 103 collect personal experience-based knowledge, analyze the collected knowledge to create new high value-added knowledge products, and provide knowledge services using the knowledge products.

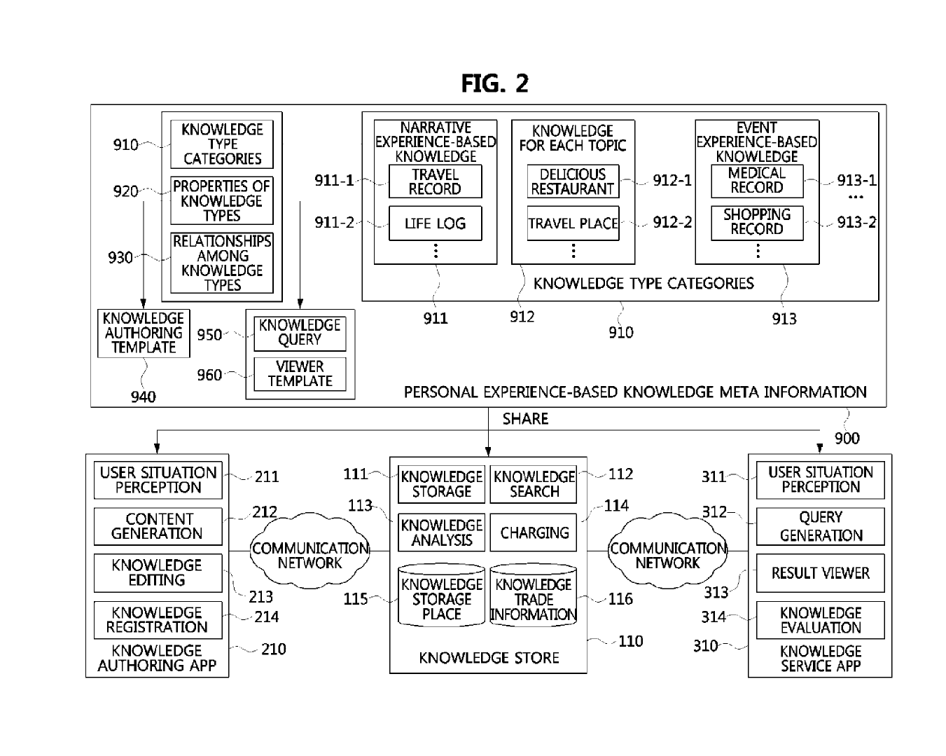

FIG. 2 is a diagram showing an example of a function for each object in a knowledge product trading method of an online store according to an embodiment of the present invention.

In order to distribute personal experience-based knowledge as shown in FIG. 1, it is necessary that meta information 900 with respect to the personal experience-based knowledge, which is an object of trade, is generated as shown in FIG. 2, and the meta information 900 is shared.

The meta information 900 of the personal experience-based knowledge for trading the knowledge products may include knowledge type categories 910 that define classification of knowledge, properties 920 of knowledge types that define components of the knowledge included in specific types, and relationships 930 among knowledge types that define relationships among the knowledge types or the components.

The meta information is created by the knowledge collection provider 102 and the knowledge collection/service provider 103. The knowledge collection provider 102 and the knowledge collection/service provider 103 may describe the meta information 900 with respect to knowledge to be collected by the knowledge collection provider 102 and the knowledge collection/service provider 103, and register the described meta information 900 in a knowledge store 110.

Although the meta information 900 of knowledge to be collected and purchased by individuals is registered in the knowledge store 110, the individuals may not collect their experiences so as to match the meta information 900 and provide the collected experiences to the knowledge collection provider 102 and the knowledge collection/service provider 103. Accordingly, the knowledge collection provider 102 and the knowledge collection/service provider 103 which collect knowledge may create a knowledge authoring template 940 for easily manufacturing the meta information about knowledge and the knowledge into knowledge products, and register the created knowledge authoring template 940 in the knowledge store 110. The knowledge authoring template 940 may have information and functions with respect to a knowledge authoring interface so that individual users who are the knowledge provider 200 easily authorize corresponding knowledge products with reference to the meta information 900 of the knowledge, and for example, may be an XML, an HTML, a script, or a program module. In addition, the knowledge authoring template 940 may be used as a detailed function of the knowledge authoring app 210.

The knowledge provider 200 executes, through the knowledge authoring app 210, the knowledge authoring template 940 that is registered by the knowledge collection provider 102 and the knowledge collection/service provider 103 which collect knowledge, to generate his/her own experience-based knowledge.

Here, the knowledge authoring app 210 may include at least one of a user situation perception function 211, a content generation function 212, a knowledge editing function 213, and a knowledge registration function 214.The user situation perception function 211 of the knowledge authoring app 210 may infer a current behavior, a location, and a movement path of a user from, for example, a mobile terminal's GPS, sensor information such as acceleration, time, or intensity of illumination, and log information such as an app use history of a mobile terminal, phone, or text.

The content generation function 212 refers to filling the knowledge authoring template 940 executed by the user with contents.

The knowledge editing function 213 refers to an editing process that modifies and deletes wrong or missing parts of experience-based knowledge generated by individual users before selling knowledge or privacy protection targets.

The knowledge registration function 214 refers to transmitting experience-based knowledge to the knowledge distributor 100 which is the knowledge collection provider 102 and the knowledge collection/service provider 103 which distribute the knowledge authoring app 210.

The knowledge store 110 stores the knowledge transmitted by the knowledge provider 200 in a knowledge storage place 115, processes a knowledge search 112 request input from the knowledge consumer 300, and transmits a result of the knowledge search 112 and performs knowledge analysis 113 for analyzing personal experience-based knowledge stored in the knowledge storage place 115 to thereby derive new knowledge products.

The knowledge collection provider 102 and the knowledge collection/service provider 103 which are the knowledge distributor 100, in order to operate the knowledge store 110, may store knowledge trade information 116 about the knowledge used by the knowledge consumers 300 through the knowledge service app 310.

The knowledge trade information 116 may be utilized as charging information with respect to use of knowledge between the knowledge service provider 101 and the knowledge collection/service provider 103, which compensate the knowledge provider 200 for knowledge products which will be widely used in the future or sell the knowledge products to the knowledge consumers 300 or between the knowledge consumers 300.

The knowledge service app 310 is used by the knowledge consumers 300. The knowledge service app 310 may be classified into functions such as user situation perception 311, query generation 312, result viewer 313, knowledge evaluation 314, and the like.

The user situation perception function 311 refers to a function of tracing a location, a time, and a behavior of a user who executes the knowledge service app 310.

The above-described functions may be used as information for expanding a query condition when performing a keyword search using the knowledge service app 310 by a user who is one of the knowledge consumers 300.

Since target knowledge of the knowledge services does not have a fixed structure and properties, the form of services that can be easily understood by users has to be defined in advance with reference to knowledge type categories 910, properties of the knowledge types 920, and relationships among the knowledge types 930. In order to provide a variety of types of knowledge services to users through the knowledge service app 310, a knowledge query template 950 and a knowledge viewer template 960 are required.

The knowledge query template 950 may have a required function and operation sequence for providing a specific knowledge service and information and functions about a query generation method for each function, or is executed in conjunction with the knowledge query template, and may be, for example, an XML, an HTML, a script, or a program module.

The knowledge viewer template 960 may have information and functions about a method of showing a query result to a user, and may be, for example, an XML, an HTML, a script, or a program module.

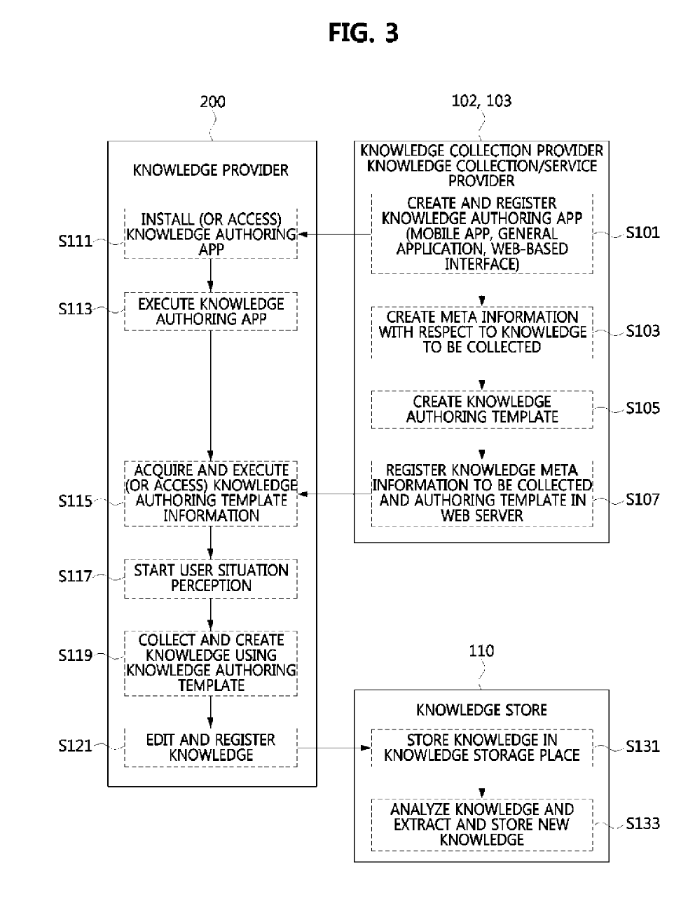

FIG. 3 is a diagram showing an example of a knowledge-providing procedure of a knowledge product trading method of an online store according to an embodiment of the present invention.

In operation S101, in order to collect personal experience-based knowledge, the knowledge collection provider 102 and the knowledge collection/service provider 103 which collect knowledge may manufacture the knowledge authoring app 210 in the form of an application program, a mobile app, or a web interface, which allows individuals to intellectualize their own experiences, and register or install the manufactured knowledge authoring app 210 in an app store or a web server.

In operation S103, the knowledge collection provider 102 and the knowledge collection/service provider 103 may create meta information 900 about knowledge to be collected.

In operation S105, the knowledge collection provider 102 and the knowledge collection/service provider 103 may create a knowledge authoring template 940 that is operated in the knowledge authoring app 210.

The knowledge authoring template 940 may be operated as a sub module in the knowledge authoring app 210 or provided to an interface on a web to be operated in conjunction with the knowledge authoring app 210.

In operation S107, the knowledge collection provider 102 and the knowledge collection/service provider 103 may register or install the meta information 900 of the knowledge to be collected and the authoring template 940 in the web server.

In operation S111, the knowledge provider 200 may receive the knowledge authoring app 210 from the app store, and install the received knowledge authoring app 210 or access the web interface.

In operation S113, the knowledge provider 200 may install or execute the knowledge authoring app 210 in the web interface.

In operation S115, the knowledge provider 200 may obtain and execute the knowledge authoring template 940 or access the web interface.

In operation S117, the user situation perception function may be automatically performed whenever components of knowledge are generated using the knowledge authoring template, and may thereby be added as a part of the knowledge.

In operation S119, the knowledge provider 200 may perform knowledge collection and creation using the knowledge authoring template 940.

In operation S121, when the knowledge collection or creation is completed, the knowledge provider 200 may edit the knowledge, and then perform a knowledge registration procedure that registers the edited knowledge in the knowledge store through a knowledge registration interface provided by the knowledge collection provider 102 and the knowledge collection/service provider 103.

In operation S131, when the knowledge registration procedure is performed by the knowledge provider 200, the knowledge store 110 may store corresponding knowledge in the knowledge storage place 115.

In operation S133, the knowledge store 110 may extract and store new knowledge by analyzing the registered knowledge.

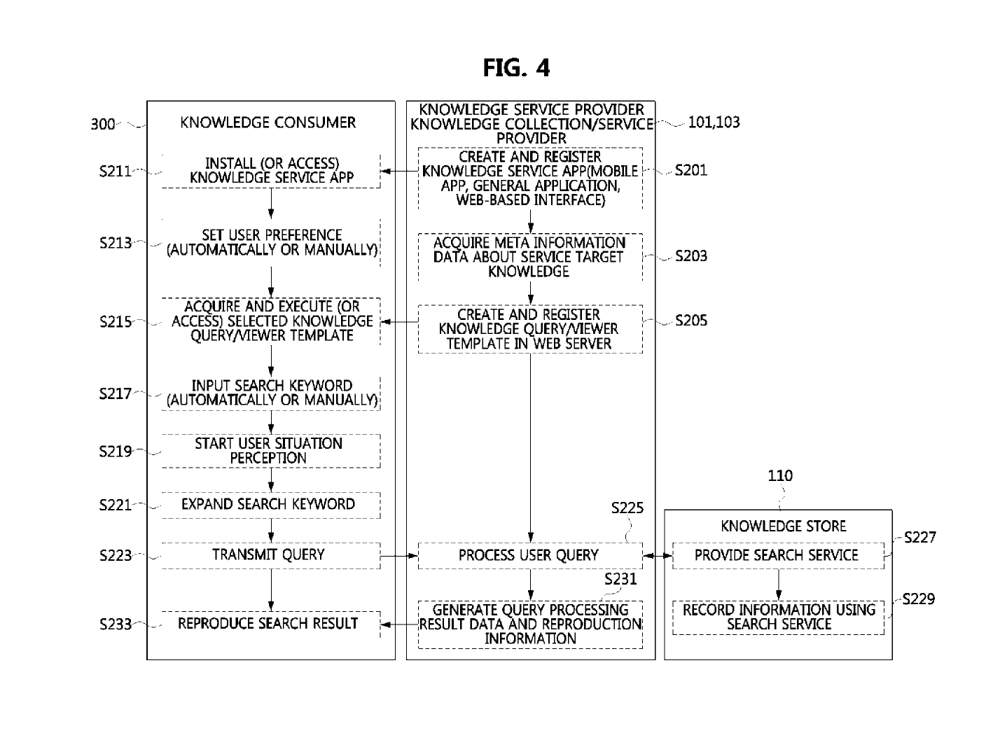

FIG. 4 is a diagram showing an example of a knowledge consumption procedure of a knowledge product trading method of an online store according to an embodiment of the present invention.

In operation S201, the knowledge service provider 101 and the knowledge collection/service provider 103 which sell knowledge may manufacture the knowledge service app 310 in which functions to be provided as a knowledge service by the knowledge service provider 101 and the knowledge collection/service provider 103 are implemented through, for example, a mobile app, a general application program, and a web-based interface, and register and install the manufactured knowledge service app 310 in the app store or the web server.

The knowledge service app 310 may be executed including or in conjunction with the knowledge query template 950 and the knowledge viewer template 960.

In operation S203, the knowledge service provider 101 and the knowledge collection/service provider 103 may acquire meta information 910, 920, and 930 data of knowledge which are knowledge service targets after creating the knowledge service app 310.

In operation S205, the knowledge service provider 101 and the knowledge collection/service provider 103 may create the knowledge query template 950 and the knowledge viewer template 960 with respect to individual knowledge services which are operated in the knowledge service app 310, with reference to the acquired meta information 910, 920, and 930 data, and register or install the created knowledge query template 950 and knowledge viewer template 960 in the web server.

In operation S211, in order to purchase knowledge products from the knowledge service provider 101 and the knowledge collection/service provider 103, the knowledge consumer 300 may install the knowledge service app 310 from the app store or access a web interface.

In operation S213, when executing the knowledge service app 310 by the knowledge consumer 300, preference information of a user may be initially set.

The setting of the preference information may be automatically or manually performed, and for example, performed by automatically extracting the preference information from log information of a user's mobile terminal or web log information.

In operation S215, when selecting a desired knowledge service from the knowledge service app 310, the knowledge consumer 300 may receive the knowledge query template 950 and knowledge viewer template 960 corresponding to the selected service from the app store, or access the web interface.

In operation S219, a situation perception function may be performed whenever keywords for the knowledge services are input using the knowledge query template 950.

In operation S221, search keywords may be automatically expanded.

In operation S223, when a query including the expanded search keywords is created, the knowledge consumer 300 may transmit the query through a query interface provided by the knowledge service provider 101 and the knowledge collection/service provider 103.

The knowledge service provider 101 and the knowledge collection/service provider 103 may perform a query processing function S225 with respect to the input query using a search service S227 provided by the knowledge store 110.

Here, in operation S229, knowledge trade information 116 may be stored in a database by the knowledge service provider 101 and the knowledge collection/service provider 103 using the search service with respect to the knowledge within the knowledge store 110.

In operation S231, the knowledge service provider 101 and the knowledge collection/service provider 103 may generate a query processing result so as to match viewer information defined in the knowledge viewer template 960, and transmit the generated query processing result to the knowledge consumer 300.

In operation S233, the knowledge consumer 300 may reproduce and confirm a query processing search result with respect to the knowledge.

As described above, according to the embodiments of the present invention, the online store for trading knowledge products may provide a knowledge service method and procedure for distributing user experience-based knowledge including experiences and contents of individuals.

While the example embodiments of the present invention and their advantages have been described in detail, it should be understood that various changes, substitutions and alterations may be made herein without departing from the scope of the invention.

What is claimed is:

1. A knowledge product trading method of an online store as an operation method of an online knowledge trading system, the knowledge product trading method comprising:
providing a knowledge authoring application (app); and
collecting knowledge from a knowledge provider through the knowledge authoring app.

2. The knowledge product trading method of claim 1, further comprising:
providing a knowledge service app;
receiving a knowledge query request from a knowledge consumer through the knowledge service app; and
selling the knowledge collected through the knowledge authoring app in response to the knowledge query request.

3. The knowledge product trading method of claim 1, wherein the knowledge authoring app is executed including or in conjunction with a knowledge authoring template having information and functions of a knowledge authoring interface, so that the knowledge provider easily authorizes knowledge of individuals as knowledge products including meta information.

4. The knowledge product trading method of claim 3, wherein the meta information includes at least one of knowledge type categories, properties of knowledge types, and relationships among knowledge types.

5. The knowledge product trading method of claim 1, wherein the knowledge authoring app includes at least one of a user situation perception function, a content generation function, a knowledge editing function, and a knowledge registration function.

6. The knowledge product trading method of claim 5, wherein the user situation perception function infers a current behavior, a location, and a movement path of a user.

7. The knowledge product trading method of claim 1, further comprising:
generating new knowledge by analyzing at least one item of the collected knowledge.

8. The knowledge product trading method of claim 2, wherein the knowledge service app includes at least one of a user situation perception function, a query generation function, a result viewer function, and a knowledge estimation function.

9. The knowledge product trading method of claim 2, wherein the knowledge service app is executed including or in conjunction with a knowledge query template that provides a required function and operation sequence for providing a specific knowledge service, and information and a function about a query generation method for each function.

10. The knowledge product trading method of claim 2, wherein the knowledge service app is executed including or in conjunction with a knowledge viewer template that provides information and a function about a method of showing, to a user, a query result for providing a specific knowledge service.

11. The knowledge product trading method of claim 8, wherein the user situation perception function infers a current behavior, a location, and a movement path of a user.

12. A knowledge product trading method of an online store as an operation method of an online knowledge trading system, the knowledge product trading method comprising:
providing a knowledge service app;
receiving a knowledge query request from a knowledge consumer through the knowledge service app;
purchasing knowledge collected through a knowledge authoring app in response to the knowledge query request; and
selling the purchased knowledge to the knowledge consumer.
